(19) United States
(12) Patent Application Publication
(10) Pub. No.: US 2021/0227556 A1
(43) Pub. Date: Jul. 22, 2021

(54) METHOD, APPARATUS AND COMPUTER READABLE MEDIUM FOR ALLOCATING MINI-SLOTS

(71) Applicant: Nokia Solutions and Networks Oy, Espoo (FI)

(72) Inventors: Moushumi SEN, Bengaluru (IN); Suresh KALYANASUNDARAM, Bengaluru (IN); Rajeev AGRAWAL, Sunnyvale, CA (US)

(73) Assignee: Nokia Solutions and Networks Oy, Espoo (FI)

(21) Appl. No.: 17/258,567

(22) PCT Filed: Aug. 28, 2018
(86) PCT No.: PCT/US2018/048286

§ 371 Date: Jan. 7, 2021

(51) Int. Cl. H04W 72/12; H04W 72/04

(52) U.S. Cl. CPC H04W 72/121; H04W 72/1273; H04W 72/0453; H04W 72/0446; H04W 72/1257

(57) ABSTRACT

A base station including a memory and a processor. The memory is configured to store computer readable instructions. The processor is configured to execute the computer readable instructions such that the memory, the processor and the computer readable instructions cause the base station to order a plurality of reception devices according to an amount of transmission resources required to transmit transmission data to each reception device, assign transmission resources in a time slot in blocks to each of the plurality of reception devices in order from a first reception device requiring the least amount of transmission resources to a reception device among the plurality of reception devices requiring a greatest amount of transmission resources, the time slot being divided into a plurality of symbols, and transmit the transmission data to the plurality of reception devices using the assigned transmission resources.

### TECHNICAL FIELD

One or more example embodiments relate to telecommunications between a base station and connected devices.

### BACKGROUND

Conventionally, allocations of transmission resources to connected devices by a base station are performed by assigning a channel to a connected device for a time slot. These conventional methods of assigning a channel for the entire time slot lead to inefficiencies if the connected device does not need the channel for the entire time slot in order to drain out all of the transmission data for the connected device. This inefficiency is especially acute when a connected device need only send a relatively small amount of transmission data.

### SUMMARY

One or more example embodiments relate to a method for training a neural network and classifying an input using the neural network.

At least one example embodiment of the inventive concepts discloses a base station including a memory and a processor. The memory is configured to store computer readable instructions. The processor is configured to execute the computer readable instructions such that the memory, the processor and the computer readable instructions cause the base station to order a plurality of reception devices according to an amount of transmission resources required to transmit transmission data to each reception device among the plurality of reception devices, assign transmission resources in a time slot in blocks to each of the plurality of reception devices in order from a first reception device requiring the least amount of transmission resources to a reception device among the plurality of reception devices requiring a greatest amount of transmission resources, the time slot being divided into a plurality of symbols, each block among the blocks including a plurality of frequency-time resources across a plurality of frequency channels and one or more of the plurality of symbols, a first block among the blocks assigned starting with a first symbol and being assigned before a second block is among the blocks assigned starting with a second symbol, the first symbol being before the second symbol, and transmit the transmission data to the plurality of reception devices using the assigned transmission resources.

Another example embodiment of the inventive concepts discloses a base station including means for ordering a plurality of reception devices according to an amount of transmission resources required to transmit transmission data to each reception device among the plurality of reception devices, means for assigning transmission resources in a time slot in blocks to each of the plurality of reception devices in order from a first reception device requiring the least amount of transmission resources to a reception device among the plurality of reception devices requiring a greatest amount of transmission resources, the time slot being divided into a plurality of symbols, each block among the blocks including a plurality of frequency-time resources across a plurality of frequency channels and one or more of the plurality of symbols, a first block among the blocks assigned starting with a first symbol and being assigned before a second block is among the blocks assigned starting with a second symbol, the first symbol being before the second symbol, and means for transmitting the transmission data to the plurality of reception devices using the assigned transmission resources.

Another example embodiment of the inventive concepts discloses a method including ordering a plurality of reception devices according to an amount of transmission resources required to transmit transmission data to each reception device among the plurality of reception devices, assigning transmission resources in a time slot in blocks to each of the plurality of reception devices in order from a first reception device requiring the least amount of transmission resources to a reception device among the plurality of reception devices requiring a greatest amount of transmission resources, the time slot being divided into a plurality of symbols, each block among the blocks including a plurality of frequency-time resources across a plurality of frequency channels and one or more of the plurality of symbols, a first block among the blocks assigned starting with a first symbol and being assigned before a second block is among the blocks assigned starting with a second symbol, the first symbol being before the second symbol, and transmitting the transmission data to the plurality of reception devices using the assigned transmission resources.

Another example embodiment of the inventive concepts discloses a non-transitory computer readable storage medium including computer executable instructions that, when executed by a computer device at a base station, cause the base station to perform a method. The method comprising ordering a plurality of reception devices according to an amount of transmission resources required to transmit transmission data to each reception device among the plurality of reception devices, assigning transmission resources in a time slot in blocks to each of the plurality of reception devices in order from a first reception device requiring the least amount of transmission resources to a reception device among the plurality of reception devices requiring a greatest amount of transmission resources, the time slot being divided into a plurality of symbols, each block among the blocks including a plurality of frequency-time resources across a plurality of frequency channels and one or more of the plurality of symbols, a first block among the blocks assigned starting with a first symbol and being assigned before a second block is among the blocks assigned starting with a second symbol, the first symbol being before the second symbol, and transmitting the transmission data to the plurality of reception devices using the assigned transmission resources.

Further example embodiments disclose the processor being further configured to execute the computer readable instructions such that the memory, the processor and the computer readable instructions cause the base station to transmit an assignment message to each of the plurality of reception devices to assign the transmission resources to respective reception devices.

Further example embodiments disclose the processor being further configured to execute the computer readable instructions such that the memory, the processor and the computer readable instructions cause the base station to, schedule the plurality of reception devices to be assigned transmission resources during the time slot based on a priority of the transmission data for each of the plurality of reception devices.

Further example embodiments disclose the processor being further configured to execute the computer readable instructions such that the memory, the processor and the computer readable instructions cause the base station to, determine a first number of frequency-time resources required to transmit first transmission data to the first reception device in the time slot, determine a first set of symbols among the plurality of symbols to be used in transmitting the first transmission data to the first reception device in the time slot by determining a minimum number of symbols required to transmit the first transmission data to the first reception device, and assign the first number of frequency-time resources to the first reception device, the first number of frequency-time resources spread across the first set of symbols in the time slot.

Further example embodiments disclose the processor being further configured to execute the computer readable instructions such that the memory, the processor and the computer readable instructions cause the base station to, determine a second number of frequency-time resources required to transmit second transmission data to a second reception device among the plurality of reception devices, determine whether a number of remaining frequency-time resources in the first set of symbols is greater than or equal to the number of frequency-time resources required to transmit the second transmission data to the second reception device, and assign the second number of frequency-time resources required to transmit the second transmission data to the second reception device from among the number of remaining frequency-time resources in response to determining that the number of remaining frequency-time resources in the first set of symbols is greater than or equal to the second number of frequency-time resources required to transmit the second transmission data to the second reception device.

Further example embodiments disclose in response to determining that the number of remaining frequency-time resources in the first set of symbols is less than the second number of frequency-time resources required to transmit the second transmission data to the second reception device, the processor being further configured to execute the computer readable instructions such that the memory, the processor and the computer readable instructions cause the base station to, assign the remaining frequency-time resources in the first set of symbols to the second reception device for transmission of a first portion of the second transmission data to the second reception device, determine a second set of symbols among the plurality of symbols to be used in transmitting a remaining second portion of the second transmission data to the second reception device, and assign frequency-time resources to the second reception device for transmission of the remaining second portion of the second transmission data, the assigned frequency-time resources spread across the second set of symbols in the time slot.

Further example embodiments disclose the processor being further configured to execute the computer readable instructions such that the memory, the processor and the computer readable instructions cause the base station to, assign transmission resources in the time slot to another reception device after assigning the transmission resources to the plurality of reception devices. The transmission data for the other reception device has a priority which is lower than the priority for the transmission data for each of the plurality of reception devices.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of this disclosure.

FIG. 1 is a block diagram illustrating an example telecommunications system according to some example embodiments.

FIG. 2 is a block diagram illustrating an example base station according to some example embodiments.

FIG. 3 is a flow chart illustrating a method according to some example embodiments.

FIG. 4 is an example functional block diagram illustrating a device scheduler and a resource scheduler according to some example embodiments.

FIG. 5 is a flow chart illustrating another method according to some example embodiments.

FIG. 6 is a flow chart illustrating another method according to some example embodiments.

FIG. 7 is an example allocation of frequency-time resources according to some example embodiments.

FIG. 8 is another example allocation of frequency-time resources according to some other example embodiments.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. The example embodiments may, however, be embodied in many alternate forms and should not be construed as limited to only the embodiments set forth herein.

Accordingly, it should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the Figures.

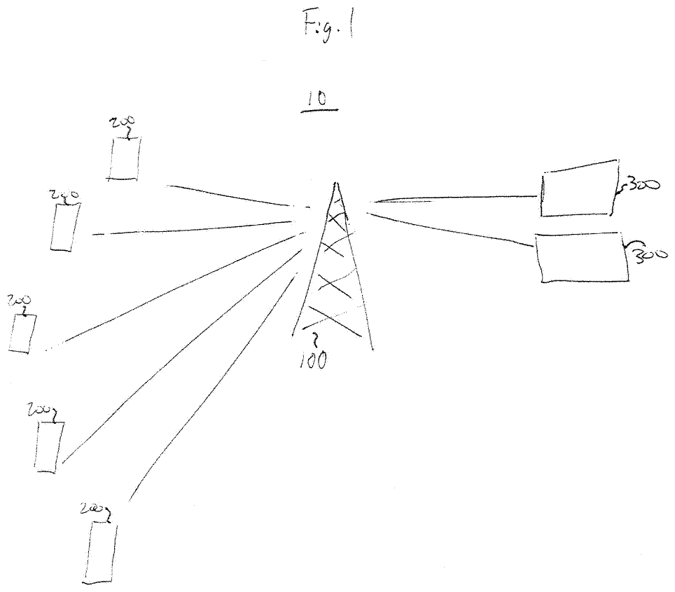

FIG. 1 is a block diagram illustrating an example telecommunications system 10 according to some example embodiments. The telecommunications system 10 may include at least one base station 100, at least one reception device 200, and at least one transmission device 300. The base station 100 may be directly or indirectly connected to the reception devices 200 and the transmission devices 300. For example, the reception devices 200 may be directly connected to a first base station 100 and the transmission devices 300 may be directly connected to a second base station 100 (not shown), which is connected to the first base station 100.

The base station 100 may be any hardware implementation that allows for communication between a transmission device 300 and a reception device 200 according to the description provided herein. For example, the base station 100 may be a cell tower or cell site.

The reception devices 200 may be servers, databases, routers, computers, smartphones, tablets or any other form of commercial or consumer electronics capable of receiving transmission data from a base station 100 on the uplink.

The transmission devices 300 may be servers, databases, routers, computers, smartphones, tablets or any other form of commercial or consumer electronics capable of transmitting transmission data to a base station 100 on the downlink.

The transmission data may be any form of digital information that may be sent over a telecommunication system. For example the transmission data may be text, image, or video files.

The connection between the base station 100 and the reception devices 200 may be through wireless communication, fiber optic cables, and/or other hardware connection such as wires and cables.

The connection between the base station 100 and the transmission devices 300 may be through wireless communication, fiber optic cables, and/or other hardware connection such as wires and cables.

Although discussed with regard to transmission devices and reception devices, each device may be a transceiver device configured to transmit data on the uplink and receive data on the downlink. Thus, a single device may be connected to the base station 100 as both a transmission device 300 and a reception device 200.

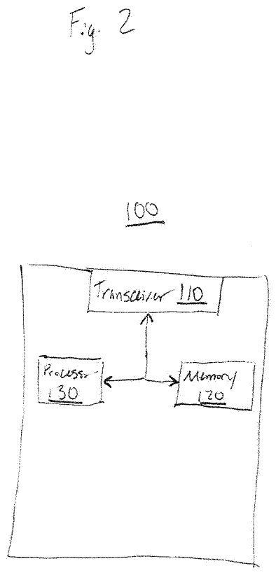

FIG. 2 is a block diagram illustrating an example base station 100 according to some example embodiments.

The base station 100 may include a transceiver 110, a memory 120, and a processor 130. The transceiver 110 may be configured to communicate with the reception devices 200 and transmission devices 300. For example, the transceiver 110 may be configured to receive transmission data from the transmission devices 300 and transmit the transmission data to the reception devices 200. The transceiver 110 may include an antenna or other form of communication hardware.

The memory 120 may store, or be configured to store, instructions for operating the base station 100. The memory 120 may be volatile or non-volatile memory or a combination thereof. For example, the memory 120 may include at least one of Random Access Memory (RAM), flash memory, and Hard Disk Drive (HDD) memory.

The processor 130 may be configured to execute the instructions stored in the memory 120 in order to operate the base station 100. The processor 130 may be any hardware components capable of performing the operations described herein. For example, the processor 130 may be include one or more CPUs or processing cores.

To transmit data to reception devices 200, for example, the base station 100 utilizes frequency and time transmission resources. In one example, the frequency resources may be divided into channels or other means of dividing a frequency spectrum. The time resources may be divided into slots. In some example embodiments, slots may be about 500 microseconds. The slots may be further subdivided into sub-slots or symbols. The symbols may be about 1/14th of the slot. A frequency-time resource may be associated with one symbol and one channel. For example, a base station 100 may have 25 channels of frequency bandwidth in which the base station 100 may assign to reception devices 200, and the time slot is divided into 14 sub-slots or symbols. In this example, the base station 100 has 350 frequency-time resources during each slot to which the base station 100 may assign to the reception devices 200.

Frequency-time resources are the smallest unit that can be allocated for data transmission. Frequency-time resources may also be referred to as frequency-time blocks. Symbols are the smallest time unit that can be allocated for data transmission. Symbols may also be referred to as sub-slots. A channel is the smallest frequency unit that may be allocated for data transmission. A channel may also be referred to as a frequency block. A channel may include multiple sub carriers. For example, in LTE and 5G, a frequency block has 12 subcarriers.

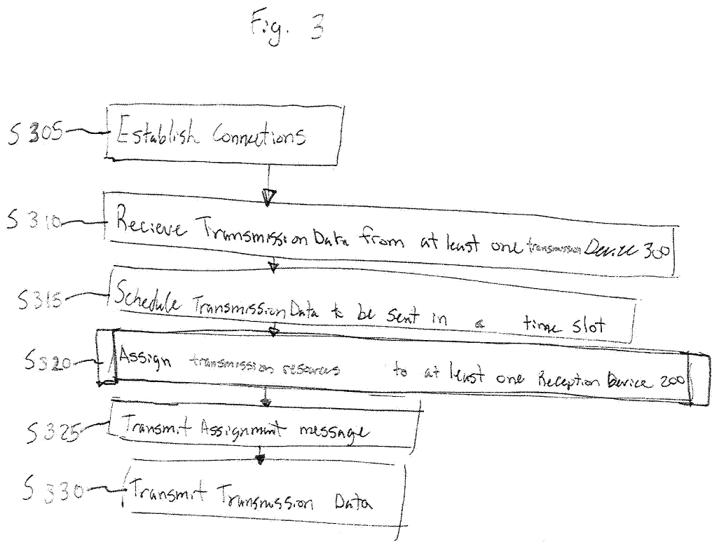

FIG. 3 is a flow chart illustrating a method according to some example embodiments. The method shown in FIG. 3 may be performed at the base station 100 shown in FIGS. 1 and 2. In some cases, the method shown in FIG. 3 will be discussed with regard to transmission between a transmission device 300 and a reception device 200.

Referring to FIG. 3, at S305, the base station 100 establishes wireless connections with the reception devices 200 and transmission devices 300.

At S310, the base station 100 receives transmission data from a transmission device 300, and buffers the transmission data in the memory 120. The transmission data may include a destination address indicating a reception device 200 to which the transmission data is to be sent.

At S315, the base station 100 schedules transmission of a portion or all of the received transmission data to the reception device 200. The transmission data may be scheduled for transmission in a slot based on characteristics of the reception device 200, priority information associated with the received transmission data, the amount of transmission data being buffered in the memory 120 for transmission, a scheduling metric for the reception device 200, and Quality of Service (QoS) requirements of the reception device 200. The priority information may indicate a priority of the received transmission data.

For example, if a portion of the received transmission data has an indication of high priority, then the base station 200 may schedule the portion of the received transmission data with high priority in the next slot. As another example, if a QoS requirement for communication with the reception device 200 requires packets of transmission data to be sent at a certain rate, then the base station may schedule the portion of the received transmission data associated with the reception device 200 in a slot such that the QoS requirements are fulfilled. The base station 100 may also determine a number of frequency-time resources required to send each portion of the transmission data to the destination reception device 200.

Still referring to FIG. 3, at S320, the base station 100 assigns transmission resources to the reception device 200 for transmission of the received transmission data. In so doing, the base station 100 may organize the transmission data which is scheduled to be sent in the time slot according to the size of the portion of transmission data relative to transmission data destined for other reception devices 200. For example, the base station 100 may organize the portions of the transmission data such that the first portion of the transmission data is the smallest and the last portion of the transmission data is the largest. Starting with the first reception device 200, the base station 100 may assign frequency-time resources to the reception devices 200 and in order from smallest number of required frequency-time resources to largest number of required frequency-time resources.

At S325, the base station 100 transmits an assignment message to each of the reception devices 200 which are assigned at least one frequency-time resource in the time slot. In an example, the base station 100 may generate one assignment message for all of the reception devices 200. In another example, the base station 100 may generate an assignment message (e.g., individual or separate assignment message) for each of the reception devices 200. The assignment message may indicate an assignment of the frequency-time resources to respective reception devices 200. If only one assignment message is generated for the time slot, then the assignment message may include assignments of frequency-time resources for each of the reception devices 200. If an individual assignment message is generated for each of the reception devices 200, then each assignment message may include the assignment of only the reception device to which the assignment message is transmitted. Frequency-time resources may be assigned in blocks and conveyed by indicating a size of an assigned block of frequency-time resources in symbols and channels and by indicating a beginning (initial or starting) frequency-time resource. The beginning frequency-time resource in the block may be the frequency-time resource associated with the lowest number channel and the first symbol.

At S330, the base station 100 transmits the transmission data to the reception devices 200 using the assigned frequency-time resources.

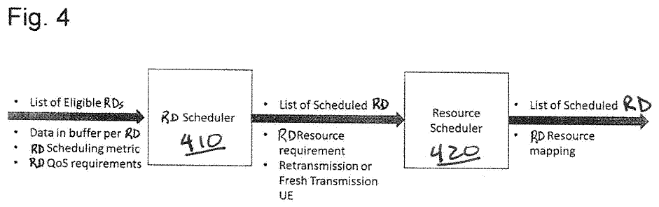

FIG. 4 is an example functional block diagram according to some example embodiments. In FIG. 4, the reception device scheduler 410 represents a functional block of the processor 130 configured to perform the operation S315 in FIG. 3 and the frequency-time resource scheduler 420 represents a functional block of the processor 130 configured to perform the operation S320 in FIG. 3.

Referring to FIG. 4, the reception device scheduler 410 may receive a list of eligible reception devices, an indication of the amount of transmission data received for each eligible reception device and/or the buffered transmission data, reception device scheduling metrics, and QoS requirements for each eligible reception device. The list of eligible reception devices may include all of the reception devices for which transmission data is buffered in the memory 120. The reception device scheduler 410 may determine a number of frequency-time resources needed to transmit the transmission data for each of the eligible reception devices based on the indication of the amount of transmission data received for each reception device or the buffered transmission data. The base station 100 may receive transmission data using frequency-time resources with characteristics similar to the frequency-time resources to be assigned to the reception devices. Accordingly, the reception device scheduler 410 may only need an indication of the number of frequency-time resources used to transmit the transmission data to the base station 100. In some example embodiments, the reception device scheduler 410 may divide the transmission data into segments suitable for transmission using the frequency-time resources. The QoS requirements may include service level requirements for transmitting data to the reception devices, data throughput requirements, whether the transmission data is a retransmission or a first transmission, or other priority information.

The reception device scheduler 410 may schedule reception devices to receive transmission data (also referred to in FIG. 3 as scheduling transmission data) by generating a list of scheduled reception devices. The reception device scheduler 410 may generate the list of scheduled reception devices by adding the reception device with the highest priority according the scheduling metric to a list of scheduled reception devices until all of the eligible reception devices are included in the list or until the number of required frequency-time resources for the scheduled reception devices reaches the number of frequency-time resources for the current time slot.

The reception device scheduler 410 may then provide the list of scheduled reception devices, the required frequency-time resources for each scheduled reception device and an indication whether the transmission data for each reception device is a first transmission or a retransmission, to the resource scheduler 420.

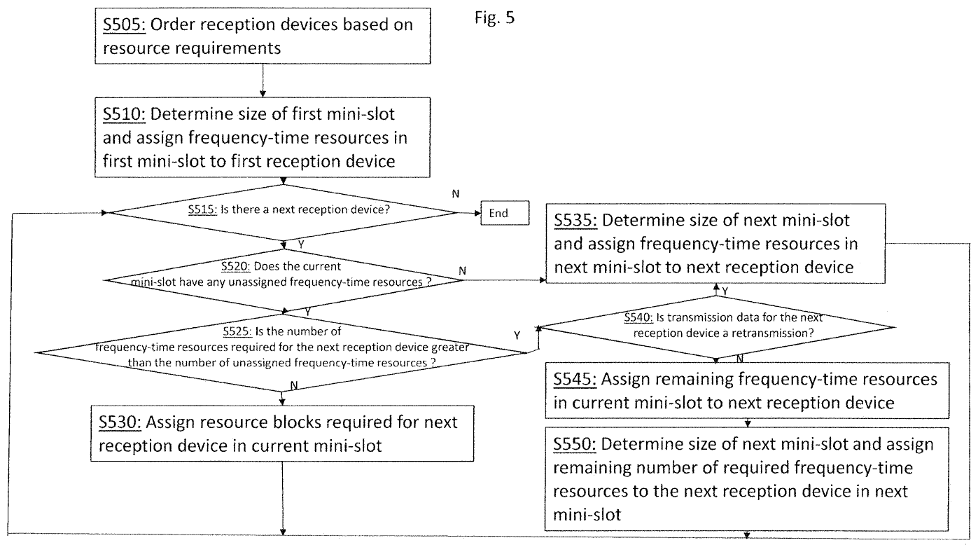

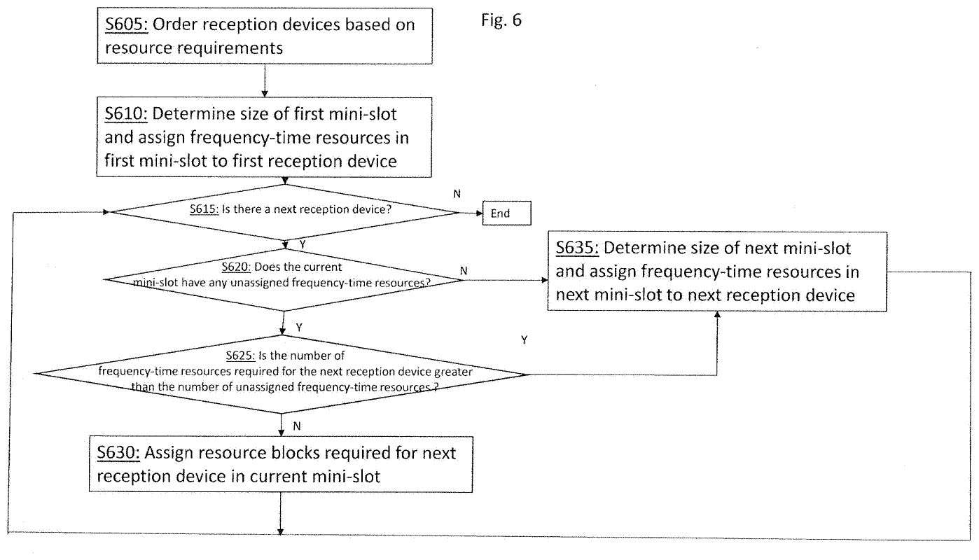

The resource scheduler 420 may operate according the operations described below with regard to FIGS. 5 and 6. The resource scheduler 420 may output the list of scheduled reception devices and resource mapping for each scheduled reception device. The resource mapping may include a beginning frequency-time resource and size of the assigned block of frequency-time resources.

The assigning of transmission resources may also be parallelized by the reception device scheduler 410 by sub-dividing the eligible reception devices into different sub-cells. Reception devices in one sub-cell may be scheduled independently from, and in parallel with, reception devices 200 in another sub-cell.

This process requires the reception device scheduler 410 to additionally determine which reception devices 200 are sufficiently orthogonal to each other such that there is minimal interference between reception devices across sub-cells, and assign reception devices 200 to sub-cells based on the determination of sufficient orthogonality. The resource scheduler 420 may then assign the frequency-time resources for the sub-cells in parallel for frequency-time resources in the same slot.

With regards to FIGS. 5-8, K represents the number of reception devices for which the base station is assigning transmission resources, Stat represents the number of symbols in the current time slot, and Cₜₒₜ represents the number of channels in which the base station 100 may allocate transmission resources. The index k represents a k-th reception device among the K reception devices. Uₖ represents the k-th reception device. Rₖ represents a number of frequency-time resources required for sending the portion of the transmission data associated with the k-th reception device Uₖ. The index s represents the s-th symbol in the time slot. The index c represents the c-th channel among the number of channels Cₜₒₜ. Hₖ represents a number of channels assigned to the k-th reception device within a given mini-slot. A frequency-time resource is represented by a symbol and a channel, for example, as the coordinates (s,c). Mₙ represents a size of a n-th mini-slot within the time slot. The size Mₙ of the n-th mini-slot may include a number of symbols within the time slot. Initially k, s, c and n may be initialized to “1.” As discussed herein, a mini-slot is a group of symbols in which the base station 100 assigns blocks the frequency-time resources. When a block is assigned to the k-th reception device, the block of assigned frequency-time resources has a width equal to the number of symbols in the current mini-slot Mₙ and a number of channels Hₖ.

While performing the operations of FIGS. 5 and 6, the base station may track the frequency-time resources which have been assigned by moving a cursor with coordinates (s,c) and maintaining the value Mₙ for the size of the current mini-slot.

FIG. 5 is a flow chart illustrating a method according to some example embodiments. Although discussed with regard to the base station 100 for simplicity, it should be understood that the method shown in FIG. 5 may be performed by the resource scheduler 420.

At S505, the base station 100 may order the reception devices in the list of K reception devices from the reception device scheduler 410 based on the transmission resource requirements for communicating the transmission data to the reception devices. In an example embodiment, the resource scheduler 420 may organize the K reception devices from the reception device requiring the least frequency-time resources to the reception device requiring the most frequency-time resources.

In another example embodiment, the base station 100 may organize the K reception devices from the least frequency-time resources needed to the most frequency-time resources needed with the exception of the lowest priority device which is organized as the last reception device. In this manner, as further described below, if a reception device cannot be allocated sufficient frequency-time resources, the reception device which does not receive a sufficient allocation will be the lowest priority reception device.

At S510, the base station 100 may determine a size M₁ of a first mini-slot (n=1) by dividing the number of frequency-time resources R₁ required for the transmitting the transmission data for the first reception device U₁ among the ordered K reception devices by the number of channels Cₜₒₜ and rounding up. More generically, the base station 100 may determine a size Mₙ of a n-th mini-slot by dividing the number of frequency-time resources Rₖ required for transmitting the transmission data to a k-th reception device at the start of a new mini-slot by the number of channels Cₜₒₜ and rounding up to the nearest integer, as shown below in Equation (1).

Mₙ=(Rₖ/Cₜₒₜ) (1)

The base station 100 may determine the number of channels H₁ within the first mini-slot to be assigned to the first reception device U₁ by dividing the required number of frequency-time resources R₁ for the first reception device U₁ by the size of the mini-slot M₁ and rounding the result to the next highest integer. More generically, the base station 100 may determine the number of channels Hₖ within the n-th mini-slot to be assigned to the k-th reception device Uₖ by dividing the required number of frequency-time resources Rₖ for the k-th reception device Uₖ by the size of the n-th mini-slot Mₙ and rounding the result up to the nearest integer as shown below in Equation (2).

H=[Rₖ/Mₙ]. (2)

The base station 100 may then assign the block B₁ of frequency-time resources within the time slot to the first reception device U₁. In this example, the assigned block B₁ begins with the frequency-time resource (1,1), the current values of s and c, and has the dimensions (M₁,H₁). The base station 100 may then record the dimensions M₁ and H₁ and the beginning frequency-time resource (1,1) for the first reception device U₁. The base station 100 may also move the cursor by setting c to H₁ plus the current value of c according to the equation c=c+H₁.

At S515, the base station 100 may determine if frequency-time resources have been assigned for all K reception devices (e.g., by comparing the index k with the number of reception devices K). If frequency-time resources for all of K reception devices have been assigned, then the process terminates for the current time slot. The base station 100 may then proceed to schedule frequency-time resources for subsequent time slots in the same or substantially the same manner as discussed herein. Accordingly, the process shown in FIG. 5 may be iterative with regard to a plurality of time slots as needed.

Returning to S515, if frequency-time resources have not been assigned to all of K reception devices the base station 100 increments the value of k (k=k+1) such that k=2, and, then at S520 the base station 100 may determine if the current mini-slot has any unassigned frequency-time resources. In one example, if c is less than or equal to Cₜₒₜ, then the base station 100 determines that unassigned frequency-time resources exist in the current mini-slot.

If there are unassigned frequency-time resources in the current mini-slot, then at S525 the base station 100 may determine whether the number of frequency-time resources R₂ required for the next reception device U₂ is greater than the number of unassigned frequency-time resources L_{M1} remaining in the current mini-slot. In one example, the number of unassigned frequency-time resources L_{M1} may be given by Equation (3) shown below.

L_{M1}=M₁(Cₜₒₜ−c+1) (3)

The base station 100 may determine whether the number of frequency-time resources R₂ is greater than the number of unassigned frequency-time resources L_{M1} by comparing R₂ and L_{M1}.

If the number of frequency-time resources R₂ required for the next reception device is less than or equal to the number of unassigned frequency-time resources L_{M1}, then at S530 the base station 100 may assign the required number of frequency-time resources for the next reception device R₂ to the next reception device U₂ in the current mini-slot. The base station 100 may assign the frequency-time resources at S530 in the same or substantially the same manner as discussed above with regard to S510. The base station 100 may then assign the block beginning with the frequency-time resource (s,c) with the dimension (M₁,H₂) to the next reception device U₂. The base station 100 may then record the block dimensions M₁ and H₂ and the beginning frequency-time resource (s,c) for the next reception device U₂. The base station 100 may also move the cursor by setting c=c+H₂. The process then returns to S515 and continues as discussed herein.

Returning to S525, if the number of frequency-time resources R₂ is greater than the number of unassigned frequency-time resources L_{M1}, then at S540 the base station 100 may determine whether the transmission data for the next reception device R₂ is a retransmission (e.g., by referencing the value output from the reception device scheduler 410).

If the transmission data for the next reception device is a retransmission, then at S535 the base station 100 may set the value of s to s+M₁ (s=s+M₁), set the value of c to 1 (c=1) and determine a size M₂ for a next mini-slot (n=2). In one example, the base station 100 may determine the size M₂ of the next mini-slot in the same or substantially the same manner as discussed above with regard to S510

The process then returns to S515 and continues as discussed herein.

Returning to S540, if the transmission data for the next reception device U₂ is not a retransmission, then at S545 the base station 100 may assign the remaining unassigned frequency-time resources L_{M1} in the current mini-slot to the next reception device U₂ by assigning the block beginning with the frequency-time resource (s,c) with the dimension (M₁,H₂) to the next reception device U₂, where H₂=(Cₜₒₜ−c+1).

At S550, the base station 100 may set s=s+M₁, set c to 1 and set the remaining frequency-time resources R′₂=(R₂−L_{M1}), determine the size M₂ of the next mini-slot (n=2) and assign the remaining number of required frequency-time resources for the next reception device U₂ in the next mini-slot. The base station 100 may determine the size of the next mini-slot with regard to (and assign) the remaining frequency-time resources R′₂ in the same or substantially the same manner as discussed above with regard to S510.

The process then returns to S515 and continues as discussed herein.

At S535 and S550, when determining the size of the next mini-slot Mₙ, the base station 100 may check whether there are sufficient symbols remaining without assigned frequency-time resources for the next mini-slot by comparing Mₙ+s with Sₜₒₜ. If there are not sufficient symbols remaining (Mₙ+s>Sₜₒₜ), then the base station 100 may determine whether there are any remaining symbols by comparing s to Sₜₒₜ. If there are any remaining symbols, then the base station 100 may determine whether the transmission data for the next reception device is a retransmission or a first (fresh) transmission by referring to the indication output from the reception device scheduler 410.

If the transmission data is a retransmission, then the base station 100 may determine if the transmission data may be sent at a higher coding rate to fit the transmission in symbols with unassigned frequency-time resources. If the transmission data cannot fit into the symbols with unassigned frequency-time resources even at the higher coding rate, the base station 100 will not allocate resources to the reception device. If the transmission data is a fresh transmission or if the transmission data is a retransmission, which may fit into the symbols with unassigned frequency-time resources, then the base station 100 may allocate any remaining frequency-time resources for the symbols with unassigned frequency-time resources to the next reception device. This may be done by allocating a block beginning at (s,c) with dimensions (Sₜₒₜ−s+1, Cₜₒₜ). The base station 100 may then record the block dimensions Mₙ (Sₜₒₜ−s+1) and Hₖ (which is Cₜₒₜ) and the beginning frequency-time resource (s,c) for the next reception device Uₖ. Increasing the coding rate may increase the occurrence of errors. Thus, alternatively, the base station 100 may not allocate the remaining frequency-time resources if the transmission data is a retransmission.

Some reception devices 200 may not be able to receive transmission data over all of the channels on which the base station 100 can transmit transmission data. In this case, base station 100 may determine a number of symbols necessary to send the portion of the transmission data to the reception device 200 and assign the mini-slots to the reception device 200 based on the restricted number of channels on which the reception device 200 is able to receive transmission data. These restrictions may be taken into account at, for example, S510, S520, S525, S530, S535, S540, S545 and S550 in FIG. 5, where applicable. For example, these restrictions may be taken into account by temporarily adjusting c or Cₜₒₜ to reflect the restrictions on channels when assigning transmission resources to the reception device 200. Information regarding the channels on which the reception device 200 may receive and transmit data may be exchanged as part of S305 in FIG. 3.

Returning now to S520 in FIG. 5, if the current mini-slot does not include unassigned frequency-time resources (L_{M1}=0), then the process proceeds to S535 and continues as discussed herein.

FIG. 6 is a flow chart illustrating yet another method according to some example embodiments. In FIG. 6, operations S605, S510, S515, S525, S530 and S535 are the same as S505, S510, S515, S525, S530 and S535, respectively. Thus, a detailed discussion is omitted. Operation S625 is similar to S525 except that if the number of frequency-time resources required for the next reception device is greater than the number of unassigned frequency-time resources in the next mini-slot n, then the base station 100 may set the s=s+Mₙ and c to 1 and proceed to S635. That is, for example, the base station 100 does not assign frequency-time resources for the next reception device to the unassigned frequency-time resources in the current mini-slot n. Rather, the base station 100 moves to the next mini-slot (n+1) to assign frequency-time resources for the next reception device.

In this manner, the base station 100 may assign each reception device only one block of frequency-time resources and reduce the computational costs to assign the frequency-time resources to the reception devices.

As can be seen in the methods described above in FIGS. 5 and 6, each block of frequency-time resources is assigned based on an order of the symbol in which the block begins, or in other words, the symbol associated with the beginning frequency-time resource. Blocks with a beginning frequency-time resource in the first symbol will be assigned before blocks with a beginning frequency-time resource associated with a later symbol.

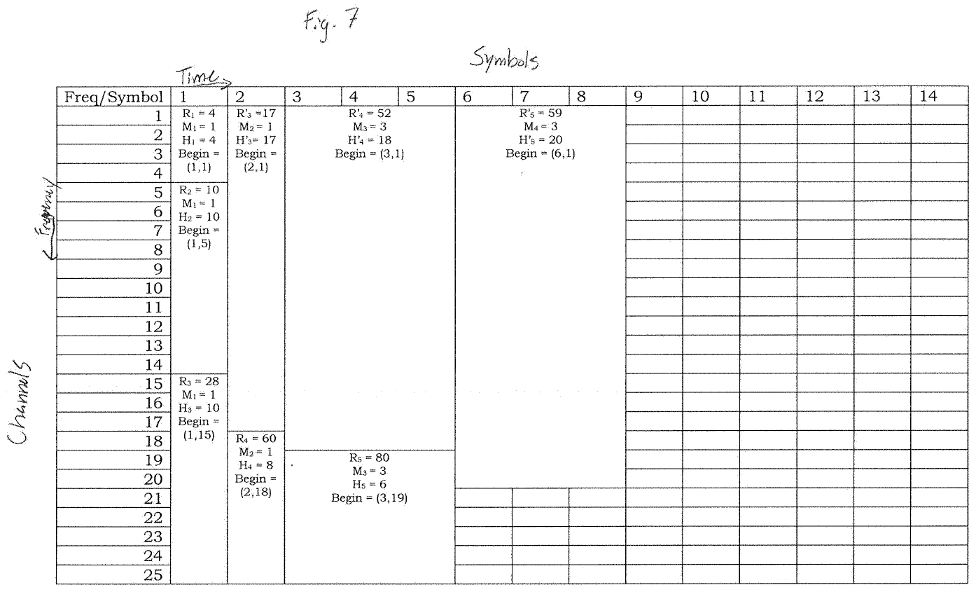

FIG. 7 is an example allocation of frequency-time resources by the base station according to the example embodiments described with regards to FIG. 5.

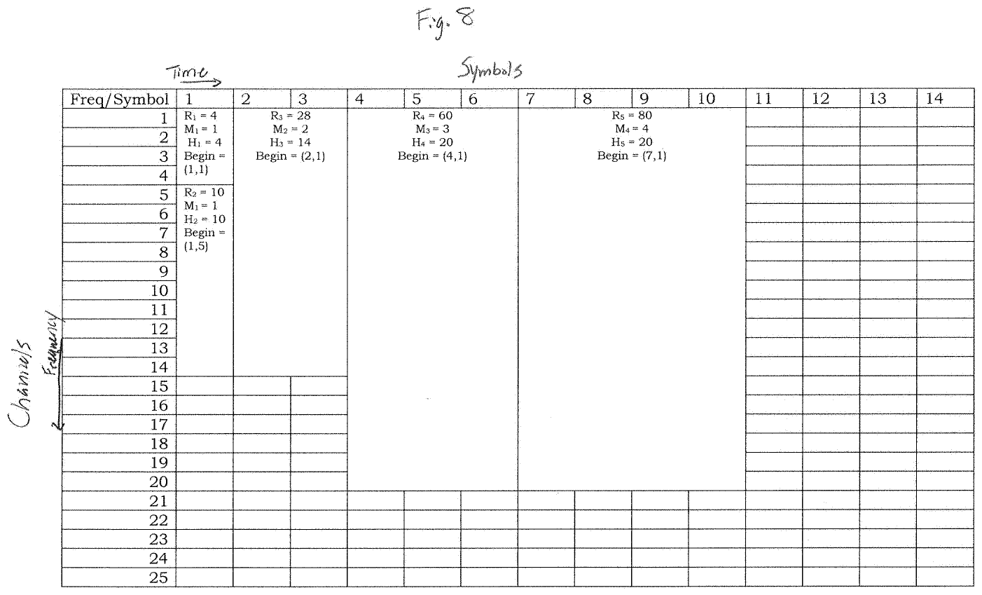

FIG. 8 is another example allocation of frequency-time resources by the base station according to the example embodiments described with regard to FIG. 6.

FIGS. 7 and 8 each show a two dimensional representation of the transmission resources. The symbols are represented across the top x axis (time) and the channels are represented across the left side y axis (frequency). The frequency-time resources are represented as the areas between the intersections of the lines representing the channels and symbols. In FIGS. 7 and 8, Mₙ is the size of the mini-slot for the n-th mini-slot. The values (s,c) represent the beginning frequency-time resource (Begin) of the assigned block. Rₖ represents the required number of frequency-time resources for the k-th reception device.

As will be appreciated by one skilled in the art, allocation methods according to example embodiments may reduce fragmentation and/or control overhead by allocating frequency-time resources for transmission of data in one or two blocks for each reception device 200.

Similar operations may be used to schedule the transmission of the transmission data to the base station 100 on the uplink.

It will be appreciated that a number of the embodiments may be used in combination.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

As discussed herein, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing control entities, clients, gateways, nodes, agents, controllers, computers, cloud based servers, web servers, proxies or proxy servers, application servers, load balancers or load balancing servers, heartbeat monitors, device management servers, or the like. As discussed later, such existing hardware may be processing entities including, inter alia, one or more Central Processing Units (CPUs), system-on-chip (SOC) devices, digital signal processors (DSPs), application-specific-integrated-circuits, field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium”, “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine-readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

The terms “including” and/or “having”, as used herein, are defined as comprising (i.e., open language). The term “coupled”, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

According to example embodiments, control entities, endpoints, clients, gateways, nodes, agents, controllers, computers, cloud-based servers, web servers, application servers, proxies or proxy servers, load balancers or load balancing servers, heartbeat monitors, device management servers, or the like, may be (or include) hardware, firmware, hardware executing software or any combination thereof. Such hardware may include one or more Central Processing Units (CPUs), system-on-chip (SOC) devices, digital signal processors (DSPs), application-specific-integrated-circuits (ASICs), field programmable gate arrays (FPGAs) computers or the like configured as special purpose machines to perform the functions described herein as well as any other well-known functions of these elements. In at least some cases, CPUs, SOCs, DSPs, ASICs and FPGAs may generally be referred to as processing circuits, processors and/or microprocessors.

The control entities, endpoints, clients, gateways, nodes, agents, controllers, computers, cloud-based servers, web servers, application servers, proxies or proxy servers, load balancers or load balancing servers, base stations, reception devices, transmission devices or the like, may also include various interfaces including one or more transmitters/receivers connected to one or more antennas, a computer readable medium, and (optionally) a display device. The one or more interfaces may be configured to transmit/receive (wireline and/or wirelessly) data or control signals via respective data and control planes or interfaces to/from one or more network elements, such as switches, gateways, termination nodes, controllers, servers, clients, and the like. Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

1. A base station comprising:
a memory configured to store computer readable instructions; and
a processor configured to execute the computer readable instructions such that the memory, the processor and the computer readable instructions cause the base station to,
order a plurality of reception devices according to an amount of transmission resources required to transmit transmission data to each reception device among the plurality of reception devices,
assign transmission resources in a time slot in blocks to each of the plurality of reception devices in order from a first reception device requiring the least amount of transmission resources to a reception device among the plurality of reception devices requiring a greatest amount of transmission resources, the time slot being divided into a plurality of symbols, each block among the blocks including a plurality of frequency-time resources across a plurality of frequency channels and one or more of the plurality of symbols, a first block among the blocks assigned starting with a first symbol and being assigned before a second block is among the blocks assigned starting with a second symbol, the first symbol being before the second symbol, and
transmit the transmission data to the plurality of reception devices using the assigned transmission resources.

2. The base station of claim 1, wherein the processor is further configured to execute the computer readable instructions such that the memory, the processor and the computer readable instructions cause the base station to transmit an assignment message to each of the plurality of reception devices to assign the transmission resources to respective reception devices.

3. The base station of claim 1, wherein the processor is further configured to execute the computer readable instructions such that the memory, the processor and the computer readable instructions cause the base station to,
schedule the plurality of reception devices to be assigned transmission resources during the time slot based on a priority of the transmission data for each of the plurality of reception devices.

4. The base station of claim 1, wherein the processor is further configured to execute the computer readable instructions such that the memory, the processor and the computer readable instructions cause the base station to,
determine a first number of frequency-time resources required to transmit first transmission data to the first reception device in the time slot,
determine a first set of symbols among the plurality of symbols to be used in transmitting the first transmission data to the first reception device in the time slot by determining a minimum number of symbols required to transmit the first transmission data to the first reception device, and
assign the first number of frequency-time resources to the first reception device, the first number of frequency-time resources spread across the first set of symbols in the time slot.

5. The base station of claim 4, wherein the processor is further configured to execute the computer readable instructions such that the memory, the processor and the computer readable instructions cause the base station to,
determine a second number of frequency-time resources required to transmit second transmission data to a second reception device among the plurality of reception devices,
determine whether a number of remaining frequency-time resources in the first set of symbols is greater than or equal to the number of frequency-time resources required to transmit the second transmission data to the second reception device, and
assign the second number of frequency-time resources required to transmit the second transmission data to the second reception device from among the number of remaining frequency-time resources in response to determining that the number of remaining frequency-time resources in the first set of symbols is greater than or equal to the second number of frequency-time resources required to transmit the second transmission data to the second reception device.

6. The base station of claim 5, wherein
in response to determining that the number of remaining frequency-time resources in the first set of symbols is less than the second number of frequency-time resources required to transmit the second transmission data to the second reception device, the processor is further configured to execute the computer readable instructions such that the memory, the processor and the computer readable instructions cause the base station to,
assign the remaining frequency-time resources in the first set of symbols to the second reception device for transmission of a first portion of the second transmission data to the second reception device,
determine a second set of symbols among the plurality of symbols to be used in transmitting a remaining second portion of the second transmission data to the second reception device, and
assign frequency-time resources to the second reception device for transmission of the remaining second portion of the second transmission data, the assigned frequency-time resources spread across the second set of symbols in the time slot.

7. The base station of claim 1, wherein the processor is further configured to execute the computer readable instructions such that the memory, the processor and the computer readable instructions cause the base station to,
assign transmission resources in the time slot to another reception device after assigning the transmission resources to the plurality of reception devices, the transmission data for the other reception device having a priority which is lower than the priority for the transmission data for each of the plurality of reception devices.

8. A method comprising:
ordering a plurality of reception devices according to an amount of transmission resources required to transmit transmission data to each reception device among the plurality of reception devices;
assigning transmission resources in a time slot in blocks to each of the plurality of reception devices in order from a first reception device requiring the least amount of transmission resources to a reception device among the plurality of reception devices requiring a greatest amount of transmission resources, the time slot being divided into a plurality of symbols, each block among the blocks including a plurality of frequency-time resources across a plurality of frequency channels and one or more of the plurality of symbols, a first block among the blocks assigned starting with a first symbol and being assigned before a second block is among the blocks assigned starting with a second symbol, the first symbol being before the second symbol; and
transmitting the transmission data to the plurality of reception devices using the assigned transmission resources.

9. The method of claim 8, further comprising:
transmitting an assignment message to each of the plurality of reception devices to assign the transmission resources to respective reception devices.

10. The method of claim 8, further comprising:
scheduling the plurality of reception devices to be assigned transmission resources during the time slot based on a priority of the transmission data for each of the plurality of reception devices.

11. The method of claim 8, wherein the assigning comprises:
determining a first number of frequency-time resources required to transmit first transmission data to the first reception device in the time slot;
determining a first set of symbols among the plurality of symbols to be used in transmitting the first transmission data to the first reception device in the time slot by determining a minimum number of symbols required to transmit the first transmission data to the first reception device; and
assigning the first number of frequency-time resources to the first reception device, the first number of frequency-time resources spread across the first set of symbols in the time slot.

12. The method of claim 11, wherein the assigning comprises
determining a second number of frequency-time resources required to transmit second transmission data to a second reception device among the plurality of reception devices;
determining whether a number of remaining frequency-time resources in the first set of symbols is greater than or equal to the number of frequency-time resources required to transmit the second transmission data to the second reception device; and
assigning the second number of frequency-time resources required to transmit the second transmission data to the second reception device from among the number of remaining frequency-time resources in response to determining that the number of remaining frequency-time resources in the first set of symbols is greater than or equal to the second number of frequency-time resources required to transmit the second transmission data to the second reception device.

13. The method of claim 12, wherein in response to determining that the number of remaining frequency-time resources in the first set of symbols is less than the second number of frequency-time resources required to transmit the second transmission data to the second reception device, assigning comprises:
assigning the remaining frequency-time resources in the first set of symbols to the second reception device for transmission of a first portion of the second transmission data to the second reception device;
determining a second set of symbols among the plurality of symbols to be used in transmitting a remaining second portion of the second transmission data to the second reception device; and
assigning frequency-time resources to the second reception device for transmission of the remaining second portion of the second transmission data, the assigned frequency-time resources spread across the second set of symbols in the time slot.

14. The method of claim 8, wherein the assigning comprises:
assigning transmission resources in the time slot to another reception device after assigning the transmission resources to the plurality of reception devices, the transmission data for the other reception device having a priority which is lower than the priority for the transmission data for each of the plurality of reception devices.

15. A non-transitory computer readable storage medium including computer executable instructions that, when executed by a computer device at a base station, cause the base station to perform a method comprising:
ordering a plurality of reception devices according to an amount of transmission resources required to transmit transmission data to each reception device among the plurality of reception devices;
assigning transmission resources in a time slot in blocks to each of the plurality of reception devices in order from a first reception device requiring the least amount of transmission resources to a reception device among the plurality of reception devices requiring a greatest amount of transmission resources, the time slot being divided into a plurality of symbols, each block among the blocks including a plurality of frequency-time resources across a plurality of frequency channels and one or more of the plurality of symbols, a first block among the blocks assigned starting with a first symbol and being assigned before a second block is among the blocks assigned starting with a second symbol, the first symbol being before the second symbol; and
transmitting the transmission data to the plurality of reception devices using the assigned transmission resources.

16. The non-transitory computer readable storage medium of claim 15, wherein the method further comprises:
transmitting an assignment message to each of the plurality of reception devices to assign the transmission resources to respective reception devices.

17. The non-transitory computer readable storage medium of claim 15, wherein the method further comprising:
scheduling the plurality of reception devices to be assigned transmission resources during the time slot based on a priority of the transmission data for each of the plurality of reception devices.

18. The non-transitory computer readable storage medium of claim 15, wherein the assigning further comprises:
determining a first number of frequency-time resources required to transmit first transmission data to the first reception device in the time slot;
determining a first set of symbols among the plurality of symbols to be used in transmitting the first transmission data to the first reception device in the time slot by determining a minimum number of symbols required to transmit the first transmission data to the first reception device; and
assigning the first number of frequency-time resources to the first reception device, the first number of frequency-time resources spread across the first set of symbols in the time slot.

19. The non-transitory computer readable storage medium of claim 18, wherein the assigning further comprises:
determining a second number of frequency-time resources required to transmit second transmission data to a second reception device among the plurality of reception devices;
determining whether a number of remaining frequency-time resources in the first set of symbols is greater than or equal to the number of frequency-time resources required to transmit the second transmission data to the second reception device; and
assigning the second number of frequency-time resources required to transmit the second transmission data to the second reception device from among the number of remaining frequency-time resources in response to determining that the number of remaining frequency-time resources in the first set of symbols is greater than or equal to the second number of frequency-time resources required to transmit the second transmission data to the second reception device.

20. The non-transitory computer readable storage medium of claim 19, in response to determining that the number of remaining frequency-time resources in the first set of symbols is less than the second number of frequency-time resources required to transmit the second transmission data to the second reception device, the assigning further comprises:
assigning the remaining frequency-time resources in the first set of symbols to the second reception device for transmission of a first portion of the second transmission data to the second reception device;
determining a second set of symbols among the plurality of symbols to be used in transmitting a remaining second portion of the second transmission data to the second reception device; and
assigning frequency-time resources to the second reception device for transmission of the remaining second portion of the second transmission data, the assigned frequency-time resources spread across the second set of symbols in the time slot.
